(19) United States
(12) Patent Application Publication
(10) Pub. No.: US 2014/0204063 A1
(43) Pub. Date: Jul. 24, 2014

(54) Portable Terminal Apparatus, Portable Terminal Control Method, And Program

(71) Applicant: Soh Kaida, Kanagawa (JP)

(72) Inventor: Soh Kaida, Kanagawa (JP)

(73) Assignee: NEC CASIO MOBILE COMMUNICATIONS, LTD., Kanagawa (JP)

(21) Appl. No.: 14/342,780

(22) PCT Filed: Jun. 22, 2012
(86) PCT No.: PCT/JP2012/004065

§ 371 Date: Mar. 4, 2014

(30) Foreign Application Priority Data
Sep. 5, 2011 (JP) 2011-192260

(51) Int. Cl. G06F 3/02; G09G 5/32

(52) U.S. Cl. CPC G06F 3/0227; G09G 5/32
USPC 345/184

(57) ABSTRACT

A portable terminal apparatus includes object display section which causes at least one operation target object to be displayed on a display unit, gripping force detecting section which detects a gripping force added to a casing, and display position control section which controls a display position of the operation target object on the display unit according to the gripping force detected by the gripping force detecting section. Accordingly, when a fingertip of a hand gripping the casing cannot reach an operation target object, the display position of the object is controlled to allow the fingertip to reach the object.

### TECHNICAL FIELD

The present invention relates to a portable terminal apparatus, portable terminal control method, and program and, in detail, to a portable terminal apparatus having a flat-plate (tablet)-shaped casing of an approximate size that can be mounted on the palm and method and program for controlling the portable terminal.

### BACKGROUND ART

In most tablet-type portable terminal apparatuses, a main input interface is a touch panel. Therefore, it is possible to perform an operation of selecting (an operation of touching) an operation target object, for example, a graphic button such as an icon or a link destination, with the thumb of one hand holding the casing. Thus, excellent operability can be advantageously achieved in a place hardly allowing the use of both hands, such as in a crowded train. However, if the screen size of the display unit is large, a fingertip may not be able to reach the operation target object, posing a problem of degraded operability such that the position of the gripping hand (gripping position) has to be changed or the operation has to be performed with both hands.

FIG. 15 is a diagram for describing inconveniences when a screen size of a display unit is large. In the drawing, a portable terminal apparatus 1 includes a longitudinally-elongated, tablet-shaped casing 2, a front surface of which is provided with a display unit also longitudinally-elongated and equipped with a touch panel (hereinafter simply referred to as a display unit 3).

When the above-structured portable terminal apparatus 1 is operated with one hand, the user grips any portion of the casing 2 with his or her dominant hand (here, a right hand 4), and moves a thumb 5 of the right hand 4 to touch the display unit 3. However, since a range the thumb 5 can reach (inside an arc 6) is limited, an area that cannot be operated with one hand (a hatched portion in the drawing, and hereinafter referred to as an operation disable area 7) occurs outside that range.

Here, when the screen size of the display unit 3 is assumed to be of, for example, a full-wide VGA (480×854 dots) on the order of approximately four inches (this screen size is a typical example today and is not an irrational example), a fingertip cannot reach the entire screen even with a standard adult thumb 5. Therefore, the operation disable area 7 of a size to some degree inevitably occurs. The location of the operation disable area 7 depends on the gripping position of the casing 2. For example, a lower portion of the casing 2 is gripped in the depicted example. In this case, the operation disable area 7 occurs mainly on an upper part of the display unit 3. This holding style (gripping the lower portion of the casing 2) is common. This is because, in most cases, any arbitrary number of physical keys 8 are provided on a lower side of the display unit 3 and these physical keys 8 have to be frequently operated with the same thumb 5.

To eliminate the operation disable area 7, a measure can be taken such that the gripping position is shifted upward or the free hand is also used. However, this poses inconveniences such that a time lag in operation occurs even for an instant in the former case and the operation ends up with both hands (the advantage of a one-hand operation is impaired) in the latter case.

To solve these inconveniences, input assist technology for supporting a one-hand operation is desired. As related art, for example, detection results from two pressure sensors provided on the surface of the casing are compared with each other and the direction and speed of scrolling are controlled based on the comparison result (Patent Document 1); the position of the hand gripping the casing is detected with a plurality of sensors provided on a side surface or a back surface of the casing and the display position of software keys on the display unit is controlled according to the griping position (Patent Document 2); or a dial-type component provided on a side surface of the casing is operated with a fingertip of the hand gripping the casing for scrolling or a button-type component provided on a side surface of the casing is pushed with a fingertip of the hand gripping the casing for scrolling (Patent Document 3).

### PRIOR ART DOCUMENTS

### Patent Documents

Patent Document 1: JP 2009-200665
Patent Document 2: JP 2010-154090
Patent Document 3: JP 11-045143

### SUMMARY OF INVENTION

### Problem to be Solved by the Invention

However, the technologies of Patent Documents 1 and 3 are merely scrolling control technologies and cannot be applied to display control over a non-scrolled screen, that is, contents not extending off screen, and the technology of Patent Document 2 merely controls a display position of the software keys according to the casing gripping position. Any of these technologies does not disclose an idea that, when a fingertip of the hand gripping a casing cannot reach an operation target object, a display position of the operation target object is controlled to allow the fingertip to reach the object.

Thus, an object of the present invention is to provide a portable terminal apparatus, portable terminal control method, and program in which, when a fingertip of the hand gripping a casing cannot reach an operation target object, a display position of the object is controlled to allow the fingertip to reach the object.

### Means for Solving the Problem

A portable terminal apparatus of the present invention comprises

object display means which causes at least one operation target object to be displayed on a display unit,

gripping force detecting means which detects a gripping force added to a casing, and

display position control means which controls a display position of the operation target object on the display unit according to the gripping force detected by the gripping force detecting means.

A portable terminal control method of the present invention comprises

an object display step of causing at least one operation target object to be displayed on a display unit,

a gripping force detecting step of detecting a gripping force added to a casing, and

a display position control step of controlling a display position of the operation target object on the display unit according to the gripping force detected in the gripping force detecting step.

A program of the present invention provides a computer of a portable terminal apparatus with functions as

object display means which causes at least one operation target object to be displayed on a display unit,

gripping force detecting means which detects a gripping force added to a casing, and

display position control means which controls a display position of the operation target object on the display unit according to the gripping force detected by the gripping force detecting means.

### Effect of the Invention

According to the present invention, it is possible to provide a portable terminal apparatus, portable terminal control method, and program in which, when a fingertip of the hand gripping a casing cannot reach an operation target object, a display position of the object is controlled to allow the fingertip to reach the object.

### BRIEF DESCRIPTION OF DRAWINGS

FIG. 1 is an external view of a portable terminal apparatus according to an embodiment.

FIG. 2 is an internal block diagram of a portable terminal apparatus.

FIG. 3 is a diagram depicting a display example of icons.

FIG. 4 is a diagram depicting an operation flow of the portable terminal apparatus 10.

FIG. 5 is a diagram for describing a threshold Fa.

FIG. 6 depicts a diagram depicting a normal gripping state.

FIG. 7 depicts a gripping state when an object positioned outside an operation range is operated and a state in which a display position of a screen reaches a predetermined move destination.

FIG. 8 is a diagram depicting a state of screen return.

FIG. 9 is a conceptual diagram depicting an example of a method of moving a screen display position.

FIG. 10 is a diagram depicting a movement characteristic of a screen display position.

FIG. 11 is a conceptual diagram when a move destination is variable.

FIG. 12 is a diagram depicting a structure with one pressure sensor.

FIG. 13 is a diagram depicting an example of structure of mechanical pressure detecting means.

FIG. 14 is a diagram depicting a structure of Supplementary Note 1.

FIG. 15 is a diagram for describing inconveniences when a screen size of a display unit is large.

### DESCRIPTION OF EMBODIMENTS

An embodiment of the present invention is described below with reference to the drawings.

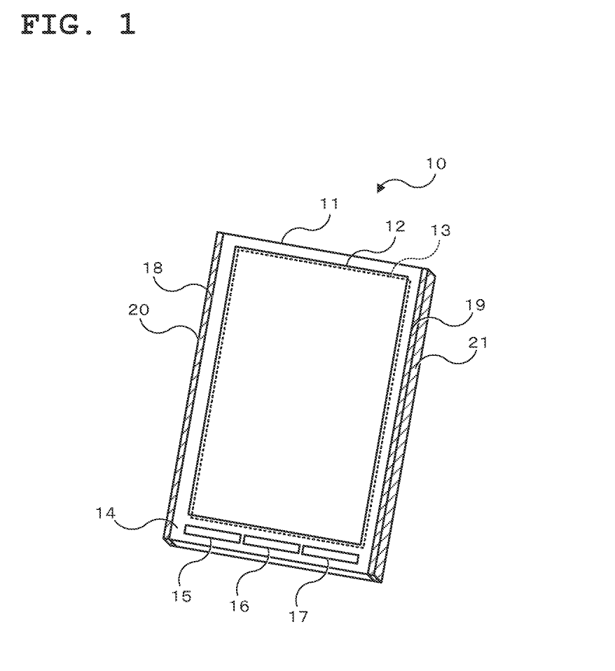

FIG. 1 is an external view of a portable terminal apparatus according to an embodiment.

In the drawing, a portable terminal apparatus 10 is, for example, a portable telephone such as a smartphone, and is structured to have a display unit 13 equipped with a touch panel 12 placed on a main surface (an operation target surface) of a tablet-shaped casing 11 of an approximate size that can be mounted on the palm, one or plurality of (here, by way of example, three) physical keys 15 to 17 placed in a frame 14 on a lower end side of the display unit 13, and plate-shaped pressure sensors 20 and 21 placed on both side surfaces (a left side surface 18 and a right side surface 19) of the casing 11, the pressure sensors each of an appropriate size that covers the entire relevant side surface. The pressure sensors 20 and 21 may be in an “exposed state”, but are desirably covered with a cover (or a cover-like substance) from an aesthetic point of view. The cover (or the cover-like substance) can be any as long as it can transmits a gripping force added to the casing 11 to the pressure sensors 20 and 21. It is assumed herein that the pressure sensor 20 placed on the left side surface 18 of the casing 11 is referred to as a “left pressure sensor 20” and the pressure sensor 21 placed on the right side surface of the casing 11 is referred to as a “right pressure sensor 21”.

The use purpose of the physical keys 15 to 17 is not particularly restricted. For example, according to a general example, the physical key 15 on the left side may be used for a menu, the physical key 16 at the center may be used for returning to a home screen, and the physical key 17 on the right side may be used for returning to an immediately previous screen. Also, although not shown in the drawing, a power supply switch may be provided on any surface of the casing 11 and, furthermore, if necessary, a slot for a storage medium such as an SD card, a connector for both recharging and an external interface, etc., may be provided at any position on any surface.

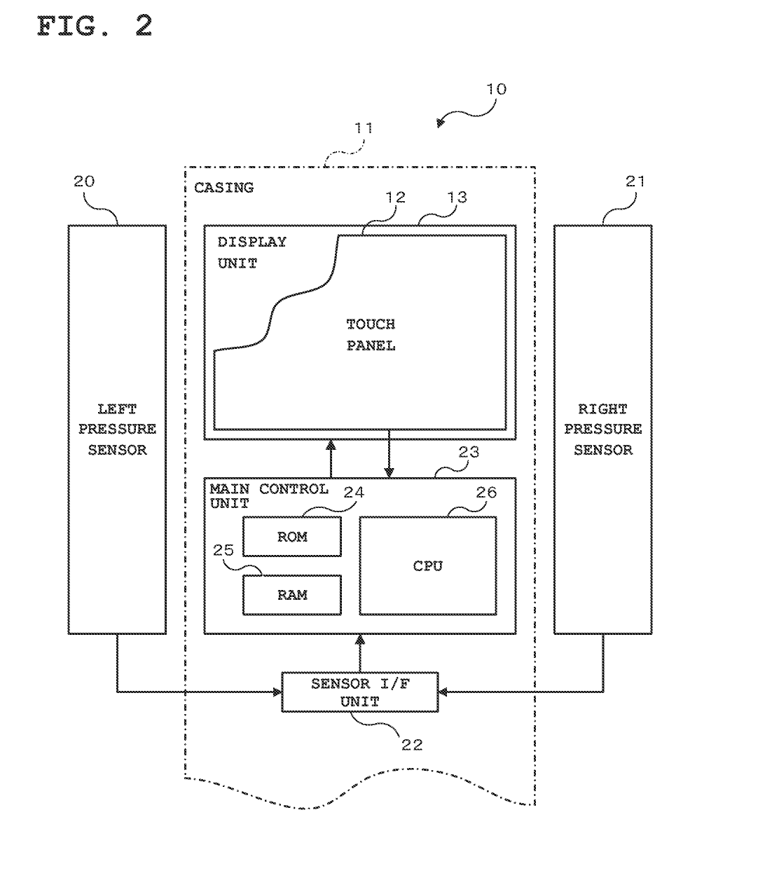

FIG. 2 is an internal block diagram of the portable terminal apparatus. In this drawing, the portable terminal apparatus 10 includes at least a sensor I/F (interface) unit 22 mounted inside the casing 11, a touch panel 12 of a capacitive type or the like, a display unit 13 such as a liquid-crystal display, and a main control unit 23. A signal from the left pressure sensor 20 and a signal from the right pressure sensor 21 are inputted to the main control unit 23 via the sensor I/F unit 22, display information generated as appropriate in the main control unit 23 is inputted to the display unit 12 and, furthermore, touch information detected in the touch panel 12 (touch coordinates on the screen of the display unit 12) is inputted to the main control unit 23. Note that when the portable terminal apparatus 10 is assumed to be a portable telephone, components for the portable telephone (such as a wireless communication unit for telephone) are provided, as a matter of course, in addition to each of the components described above.

The main control unit 23 is a control element of a program control type, loading a control program stored in advance in a non-volatile, rewritable memory (for example, such as a flash memory, a hard disk, or a silicon disk; hereinafter, a ROM 24) to a high-speed semiconductor memory (hereinafter, a RAM 25) and executing the control program at a computer (hereinafter, a CPU 26), thereby achieving various functions necessary for the portable terminal apparatus 10, for example, a function of displaying an icon, a function of generating an event correspondingly to a user operation (a touch operation) on the icon, and a function of executing a predetermined command in response to the event, via organic coupling between hardware resources such as the CPU 10 and software resources such as the control program.

The icon refers to an “operation target object” schematically representing a process detail or target by using a component such as a small picture, a sign, or a figure on an operation screen of a computer applied device. Since a user can directly touch the icon for operation, an intuitively-excellent user interface can be obtained. Note that the operation target object is not restricted to the icon. Any can be used as long as it can generate a specific event by being touched (selected). For example, link information to various documents, Internet contents, etc., (embedded in a character string or an image) or menu information may be used. Hereinafter, the icon is taken as an example for description. However, note that this is merely for the purpose of simplification of description and the meaning of the icon includes all “operation target objects”.

The details of the icon are not particularly restricted. For example, if the portable terminal apparatus 10 is a portable telephone terminal also used as an Internet terminal, the icon may be taken as an icon for telephone, an icon for mail, an icon for Internet browser, or any of icons for various tools.

In general, a plurality of these icons are placed on the display unit 13 of the portable terminal apparatus 10. Among others, a dual-purpose Internet terminal called a smartphone can download any application software from a site on the Internet to the terminal for install. Here, an icon for each application is placed on the screen, and therefore many icons corresponding to the number of pieces of application software downloaded are placed on the screen.

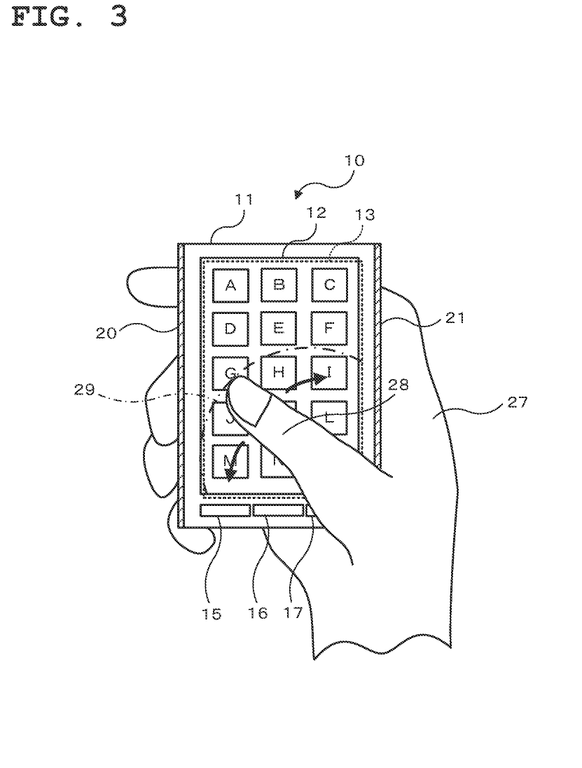

FIG. 3 is a diagram depicting a display example of icons. In this drawing, on the display unit 13 of the portable terminal apparatus 10, many icons orderly placed (here, in a matrix of three columns×five rows) are shown. Hereinafter, these icons are provided with alphabets “A” to “O” and are referred to as an A icon, a B icon . . . and an O icon. Note that the alphabets “A” to “O” do not have any particular meaning and are merely identification signs.

When any of the A icon, the B icon, . . . and the O icon is touched, an application assigned to that icon starts. For example, a telephone application starts when the A icon is touched, a mail application starts when the B icon is touched, and an Internet browser application starts when the C icon is touched. Also, a telephone book application starts when the G icon is touched, . . . a game application starts when the M icon is touched. The same goes for the other icons.

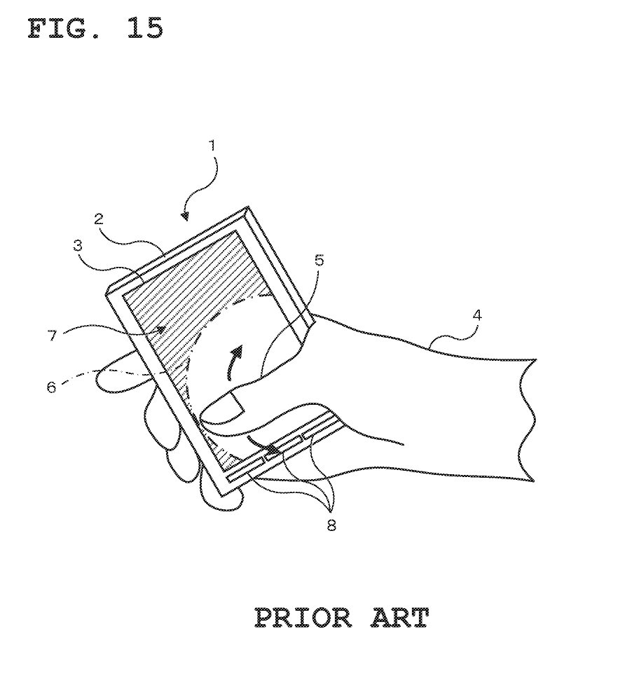

Now, consider the case in which the user grips a lower portion of the casing 11 with his or her right hand 27 and, in this state, uses a thumb 28 of the right hand 27 to touch any icon. In this case, a range the thumb 2 can reach is inside an arc 29 with a radius from the joint of the thumb 28 as a center to the tip of the thumb 28. In the example depicted in the drawing, this range (inside the arc 29) includes only the icons on the third rows onward (the G to O icons), and the other icons (the A to F icons) are out of the range (refer to the operation disable area 7 of FIG. 15). Therefore, the A to F icons positioned outside the range (refer to the operation disable area 7 of FIG. 15) cannot be selected unless the gripping position is changed or the operation is changed to an operation with both hands.

An operation with both hands loses convenience of operation with one hand. Also, a change of the gripping position, that is, a change from the lower portion to a center portion or an upper portion of the casing 11 invites degradation in operability. This is because the lower part of the casing 11 is provided with the physical keys 15 to 17, which are frequently operated, and when any of the physical keys 15 to 17 is operated after the gripping position is shifted upward, the gripping position is required to be immediately back to the original gripping position. In addition, a change of the gripping position may pose a danger that the portable terminal apparatus 10 may fall down. This is because, when the gripping position is shifted upward or is back to the original, the gripping force is weakened for a moment, thereby posing a danger that the casing 11 may slide down from the palm.

As such, measures (an operation with both hands and a change of the gripping position) for allowing selection of the operation target objects outside the operation range (in the example depicted in the drawing, the A to F icons) have the disadvantages described above, and therefore there is a problem to be solved.

The embodiment is intended to solve the problem, and the gist of the technical idea is that the display state of the screen of the display unit 13 is changed (precisely, the display position of the operation target object is changed) according to the gripping force (a grasping force, a catching force, or a holding force) of the casing 11, and the operation target objects outside the operation range can be moved to the inside of the operation range. With this, the operation target objects outside the operation range (in the example depicted in the drawing, the A to F icons) can be selected without changing the gripping position or performing an operation with both hands.

The operation of the embodiment is described in detail below.

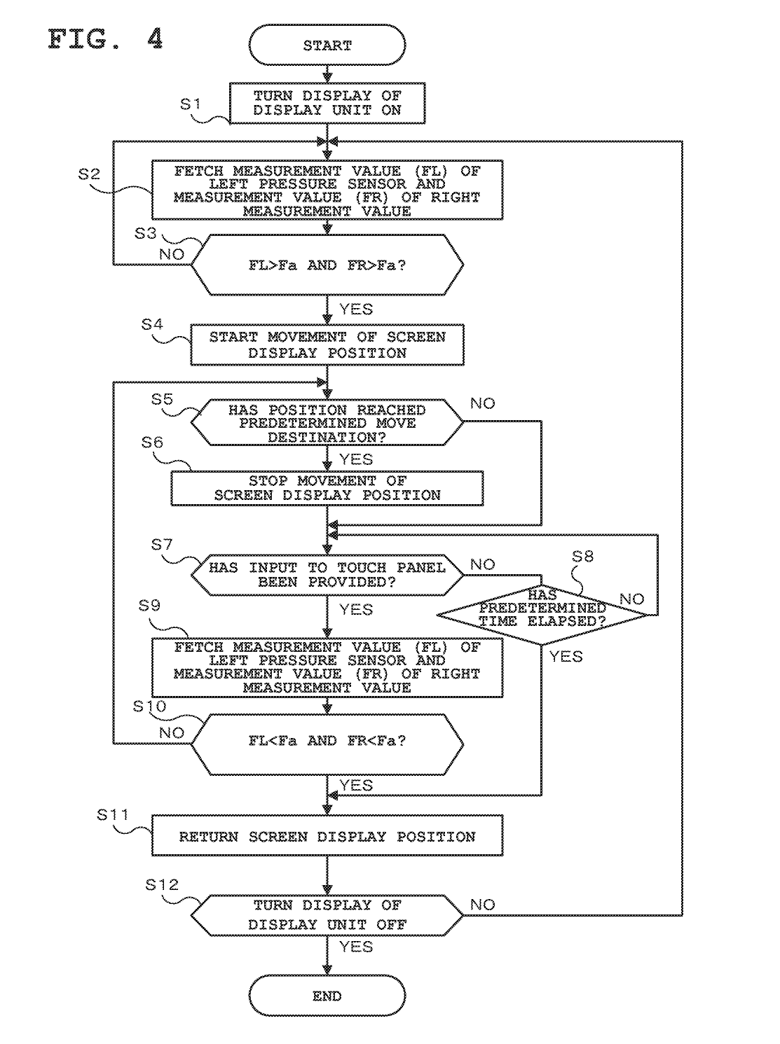

FIG. 4 is a diagram depicting an operation flow of the portable terminal apparatus 10. This operation flow schematically depicts process details of a control program to be sequentially executed by a control entity, that is, the computer (CPU 26) of the main control unit 23. Hereinafter, each process element is provided with a step number “S”+“serial number” for description.

When the operation flow starts, the CPU 26 first turns display of the display unit 13 ON (Step S1). Note that “turn display ON” means that predetermined display information generated at the main control unit 23 is inputted to the display unit 13 and a backlight (a surface light source) of the display unit 13 is lit. In this regard, the backlight is essential for the display unit 13 of a transmission type not illuminating by itself (for example, a liquid-crystal display) and is not necessary when the display unit 13 of a self-luminous type (such as an organic panel or an EL panel) is used. In this case, all that is required to do is input predetermined display information generated at the main control unit 23 to the display unit 13.

Next, the CPU 26 fetches a measurement value (hereinafter, FL) of the left pressure sensor 20 and a measurement value (hereinafter, FR) of the right pressure sensor 21 (Step S2), and compares these values FL and FR and a predetermined threshold Fa to determine whether “FL>Fa and FR>Fa” (Step S3).

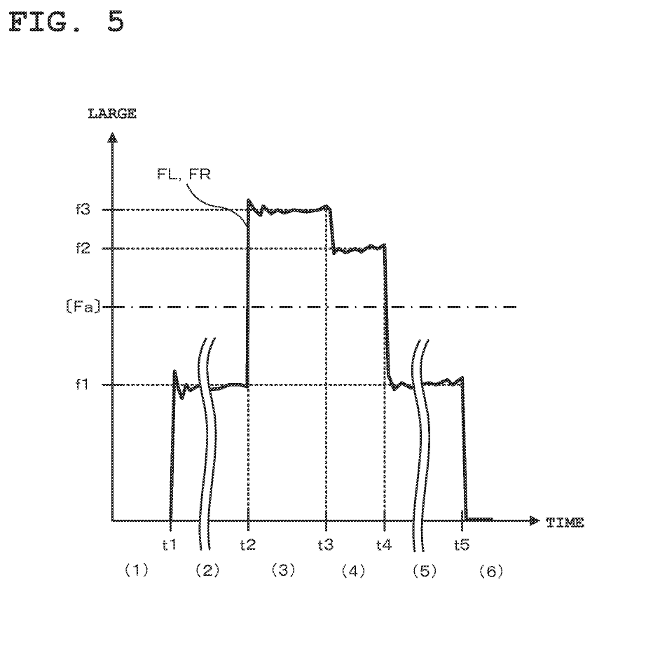

FIG. 5 is a diagram for describing the threshold Fa. In this drawing, the horizontal axis represents time and the vertical axis represents pressure. The pressure corresponds to the measurement values (FL and FR) of the left pressure sensor 20 and the right pressure sensor 21, and the pressure is larger as it goes higher on the vertical axis.

In this drawing, modification examples of FL and FR along the time are depicted as follows.

(1) until time t1: pressure is approximately 0.

(2) times t1 to t2: pressure f1 (f1>0).

(3) times t2 to t3: pressure f3 (f3>f1).

(4) times t3 to t4: pressure f2 (f3>f2>f1).

(5) times t4 to t5: pressure f1.

(6) time t5 onward: pressure is approximately 0.

In (1) and (6), since the gripping forces (FL and FR) added to the casing 11 are approximately 0, this means that the portable terminal apparatus 10 is in a non-gripped state. On the other hand, in (2) to (5) other than the above, since the gripping forces (FL and FR) added to the casing 11 have significant values (the pressures f1 to f3) exceeding 0, this means that the portable terminal apparatus 10 is at least in a gripped state.

Here, attention is paid to two pressures, the pressure f1 and the pressure f3. As depicted in the drawing, the pressure f1 and the pressure f3 both exceed approximately 0 and the pressure f3 is larger than the pressure f1. Therefore, in (2) and (5) where the pressure f1 is detected, the state is such that the casing 11 is being gripped with a light force corresponding to the pressure f1. In (3) where the pressure f3 is detected, the state is such that the casing 11 is being gripped with a strong force corresponding to the pressure f3.

Now, it is assumed that the pressure f1 represents a value corresponding to the gripping force of a general user for gripping the casing 11. That is, the pressure f1 is assumed to correspond to an average pressure to be added to both side surfaces of the casing 11 when most users simply grip the casing 11. Hereinafter, this pressure f1 is referred to as a “normal gripping force” for convenience. That is, the normal gripping force=f1. By contrast, the pressure f3 has a magnitude exceeding the normal pressure, and also has a value corresponding to a pressure when a force is intentionally added to the palm. Hereinafter, this intentionally-added pressure is referred to as an “intentional gripping force” for convenience. That is, the intentional gripping force=f3.

The threshold Fa is set at an appropriate value so as to be able to distinguish between these “normal gripping force” and “intentional gripping force”. For example, in the example depicted in the drawing, the threshold Fa is set at an approximately intermediate value between f1 and f3.

Note that the pressure f2 in (4) has a value smaller than the pressure f3 and larger than the pressure f1 and also above the threshold Fa. This pressure f2 is also included in the range of the “intentional gripping force”. That is, the pressure f2 represents a value when an operation target object on the screen is touched with the “intentional gripping force” being kept. In general, when a touch operation as described above is performed, the gripping force tends to slightly decrease. A difference between the pressure f3 and the pressure f2 represents this decreases in gripping force.

Therefore, FL and FR depicted in the drawing have characteristics indicating a lapse of time such that the state is a non-gripping state in (1), the state is a gripping state with the normal gripping force f1 in (2), the state is a gripping state with the intentional gripping force f3 in (3), the state is a gripping state with the intentional gripping force f2 and includes a touch operation in (4), the state is a gripping state with the normal gripping force f1 (5), and the state is a non-gripping state in (6). It is clearly demonstrated that by setting the threshold Fa appropriately, it is possible to distinguish between the gripping state with the normal gripping force f1 and the gripping states with the intentional gripping forces f2 and f3.

Referring back to FIG. 4 again, when the determination result at Step S3 is “NO”, that is, when “FL>Fa and FR>Fa” does not hold, it is determined that the state is any one of the states other than (3) and (4) of FIG. 5, in detail, the state is the non-gripping state in (1), the state is the gripping state with the normal gripping force f1 in (2) or (5), and the state is the non-gripping state in (6). The procedure then returns to Step S2 again to fetch the measurement values (FL and FR) of the left pressure sensor 20 and the right pressure sensor 21.

On the other hand, when the determination result at Step S3 is “YES”, that is, when “FL>Fa and FR>Fa” holds, it is determined that the state is any one of the states in (3) and (4) of FIG. 5, in detail, the state is the gripping state with the intentional gripping force f3 in (3) and the state is the gripping state with the intentional gripping force f2 and includes a touch operation in (4), and movement of the screen display position of the display unit 13 is started (Step S4). Here, “movement of the screen display position” means that an operation target object outside the operation range is moved to the inside of the operation range of the thumb 28. For example, description is made with the example of FIG. 3. The icons A to F depicted in the drawing are operation target objects outside the operation range of the thumb 28, and these icons A to F are moved to the inside of the operation range, that is, the inside of the arc 29. A specific method of moving the screen display position will be described further below.

When movement of the screen display position of the display unit 13 is started at Step S4, it is next determined whether the position has reached a predetermined move destination (Step S5). “Has reached a predetermined move destination” means that the operation target objects have been positioned (have reached) inside the operation range. This will also be described further below in detail.

When the determination result at Step S5 is “YES”, that is, if the screen display position of the display unit 13 has reached the predetermined move destination, the movement of the screen display position is stopped (Step S6), and it is determined whether an input to the touch panel 12 (a touch operation) has been provided (Step S7). On the other hand, when the determination result at Step S5 is “NO”, that is, if the screen display position of the display unit 13 has not reached the predetermined move destination, the procedure directly proceeds to a process of determining whether an input to the touch panel 12 (a touch operation) has been provided (Step S7).

When the determination result at Step S7 is “YES”, that is, if it is determined that an input to the touch panel 12 (a touch operation) has been provided, the measurement values (FL and FR) of the left pressure sensor 20 and the right pressure sensor 21 are fetched again (Step S9), and these measurement values FL and FR and the predetermined threshold Fa are compared to determine whether “FL<Fa and FR<Fa” (Step S10).

Then, when the determination result at Step S10 is “NO”, that is, when “FL<Fa and FR<Fa” does not hold, it is determined that the state is any one of the states in (3) and (4) of FIG. 5, in detail, the state is the gripping state with the intentional gripping force f3 in (3), and the state is the gripping state with the intentional gripping force f2 and includes a touch operation in (4) continues, and Step S5 onward is performed again.

On the other hand, when the determination result at Step S10 is “YES”, that is, when “FL<Fa and FR<Fa” holds, it is determined that the state is any one of the states other than (3) and (4) of FIG. 5, in detail, the non-gripping state in (1), the gripping state with the normal gripping force f1 in (2) and (5), or the non-gripping state in (6), the screen display position is returned (Step S11), and it is then determined whether to turn display of the display unit 13 OFF (Step S12).

If display is to be turned OFF, a display information output from the main control unit 23 to the display unit 13 is stopped (and the backlight is shut off if the display unit 13 is of a transmission type) to end the flow. If display is not to be turned OFF, Step S2 onward is repeated again.

When the determination result at Step S7 is “NO”, that is, if it is not determined that an input to the touch panel 12 (a touch operation) has been provided, it is determined whether a predetermined time corresponding to an average time for waiting a touch operation after the state becomes a gripping state with the intentional gripping force has elapsed (Step S8). If the predetermined time has not elapsed, the determination at Step S7 is repeated again. If the predetermined time has elapsed, it is determined that the state is a gripping state with a wrong strong force not for the purpose of a touch operation, and the process of returning the screen display position (Step S11) is performed.

With the operation flow described above, the operation target objects outside the operation range are moved to the inside of the operation range, thereby allowing the operation target objects outside the operation range (in the example depicted in FIG. 3, the A to F icons) to be selected without changing the gripping position or performing an operation with both hands. As a result, the problem of the embodiment described above can be solved. For further ease of understanding, a specific example is described below.

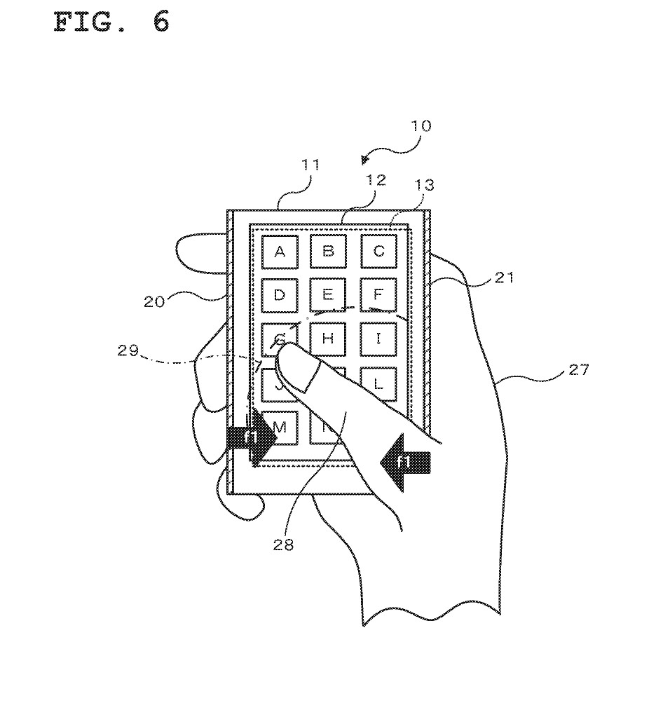

FIG. 6 depicts a diagram depicting a normal gripping state. As depicted in this drawing, the user grips the casing 11 with the right hand 27, and his or her gripping force is the normal gripping force f1 smaller than the threshold Fa. Therefore, in this case, the determination result at Step S3 is “NO” and therefore movement of the screen display position (Step S6) is not performed, and the display state of the display unit 13 is not changed.

In the display state depicted in the drawing, operation target objects positioned inside the operation range of the thumb 28 (inside of the arc 29) are the icons G to O. The user can operate any of these icons G to O with the thumb 28 without changing the gripping position. However, the icons A to F positioned outside the operation range (outside the arc 29) cannot be operated as they are.

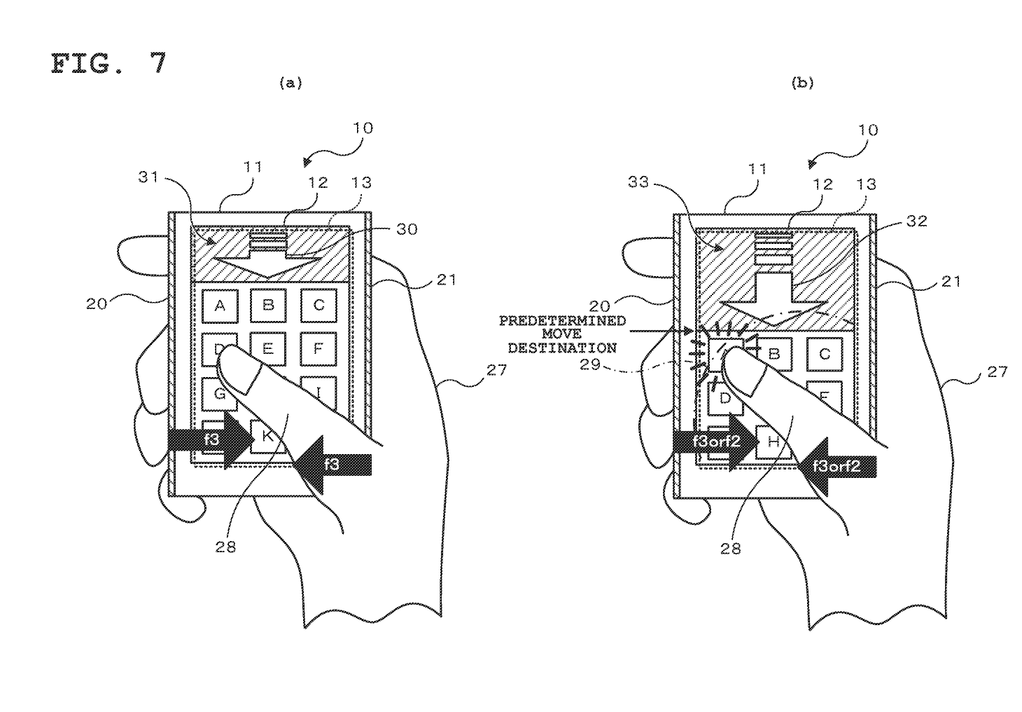

FIG. 7(a) is a diagram depicting a gripping state when objects positioned outside the operation range is operated. As with the normal gripping state, the user grips the casing 11 with the right hand 27. However, there is a difference from the normal gripping state in that the gripping force is the intentional gripping force f3 larger than the threshold Fa. As depicted in this drawing, immediately after a transition from the normal gripping state to the gripping state with the intentional gripping force f3, the determination result at Step S3 is “YES”, and the start of movement of the screen display position at Step S4 is performed, and therefore the entire display information on the screen of the display unit 13 starts moving in a downward direction. A bold hollow arrow sign 30 schematically represents an operation of the movement. The operation of the movement may be for an instant, but the screen is preferably caused to slide like animation in view of presentation effects of appearance. A vacant portion due to the movement is filled with dummy background data 31 of any color or any design, and the background data 31 is increased in size in the vertical direction as the movement amount increases.

FIG. 7(b) is a diagram depicting a state in which the display position of the screen has reached the predetermined move destination. In this drawing, a bold hollow arrow sign 32 schematically representing an operation of the movement extends at maximum, and the size in the vertical direction of background data 33 is at maximum accordingly.

As described above, “has reached the predetermined move destination” means that the operation target object has been positioned (has reached) inside the operation range. That is, as depicted in the drawing, that means the time when the operation target objects originally positioned outside the operation range (the A icon to the F icon) have reached inside of the operation range (inside the arc 29). When the position has reached the predetermined move destination, the determination result at Step S5 is “YES”, and the movement of the screen display position stops (Step S6). Therefore, the user can view the stopped screen and operate a desired operation target object. In the example depicted in the drawing, the user is operating the A icon with the thumb 28.

Therefore, according to the embodiment, when an operation target object positioned outside the operation range is desired to be operated in the gripping state as it is, the user changes the gripping force of the casing 11 from the normal gripping force f1 to the intentional gripping force f3 (or f2), waits for the screen to stop movement while keeping the intentional gripping force f3 (or f2), and then operates the desired operation target object. Therefore, cumbersome tasks such as shifting the gripping position or changing to an operation with both hands are not required.

In addition, in the embodiment, only by changing the intentional gripping force f3 (or f2) of the casing 11 to the normal gripping force f1, the display of the screen can be back (returned) to the original.

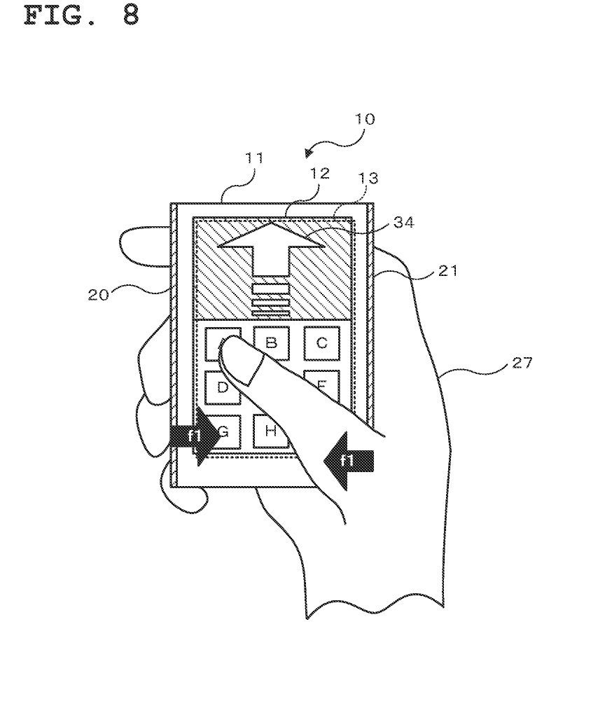

FIG. 8 is a diagram depicting the state of screen return. In this drawing, a bold hollow arrow sign 34 schematically represents a return operation. This return operation may be a slide operation as the operation at the time of movement, but a slide operation after a touch operation is not necessary (such an operation can be said as an excessive animation effect), and therefore a return for an instant is preferable. However, the technical idea does not exclude a return by a slide operation.

As depicted in the drawing, when the gripping force of the casing 11 is changed from the intentional gripping force f3 (or f2) to the normal gripping force f1, the determination result at Step S10 is “YES”, and the screen display position is returned (Step S11), and therefore the display can be returned to the original only by simply weakening the gripping force.

As has been described above, according to the embodiment, the operation target objects outside the operation range are moved to the inside of the operation range, thereby allowing any of the operation target objects outside the operation range (in the example of FIG. 3, the A to F icons) to be selected without changing the gripping position or performing an operation with both hands. As a result, the problem of the embodiment described above can be solved.

Next, a specific example of how to move the screen display position is described.

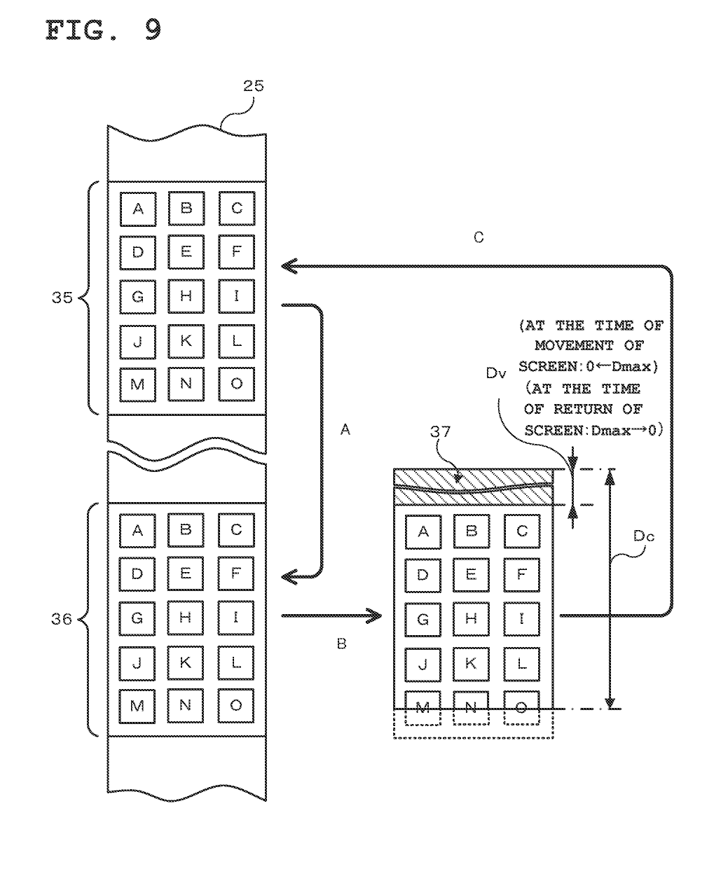

FIG. 9 is a conceptual diagram depicting an example of a method of moving the screen display position. In this drawing, an area having a storage capacity corresponding to the screen size of the display unit 13 (hereinafter, a video memory 35) is allocated in the RAM 25. The display unit 13 displays the contents of the video memory 35. Note that although the video memory 35 actually stores pixel data in the address order (data for each display pixel of the display unit 13) and the display unit 13 sequentially reads and displays the pixel data for each pixel, it is assumed in this drawing that, for simplification of description, data in the state of a display image of the display unit 13 as it is (that is, the state in which the arrangement of the A icon to the 0 icon is kept) is stored in the video memory 35.

In the embodiment, an area having the same capacity as that of the video memory 35 (hereinafter, a buffer memory 36) is further allocated in the RAM 25.

When the movement of the screen display position starts at Step S4, the contents of the video memory 35 are first copied to the buffer memory 36 (indicated as A). Next, the contents of the buffer memory 36 are read and dummy background data 37 (corresponding to the background data 31 and 33 of FIG. 7) is added to the head of the read contents (an upper end of the screen) (indicated as B). From the head of the entire screen with the added background data 37, a predetermined length Dc is cut out to rewrite the contents of the video memory 35 (indicated as C).

Here, the predetermined length Dc is a length corresponding to the number of pixels in a vertical direction (a longitudinal direction) of the display unit 13. For example, when the screen size of the display unit 13 is of a full-wide VGA (480×854 dots) on the order of approximately four inches, the length corresponds to 854 dots. Also, a size Dv in the vertical direction of the background data 37 sequentially increases from 0 to a predetermined value (Dmax) at the time of movement of the screen and, every time the size Dv in the vertical direction of the background data 37 increases, the operation C is performed, that is, the operation of cutting out the predetermined length Dc from the head of the entire screen with the added background data 37 to rewrite the contents of the video memory 35 is performed.

Therefore, by repeating this operation C, the screen display position can be moved. Also, the predetermined value (Dmax) corresponds to the predetermined move destination. If the size Dv in the vertical direction of the background data 37 has reached Dmax, the screen display position is not moved any Note that when the screen is returned, the operation C is performed while the size Dv in the vertical direction of the background data 37 is gradually decreased from the predetermined value (Dmax) to 0 or the operation C is performed after the size Dv in the vertical direction of the background data 37 is returned to 0 for an instant.

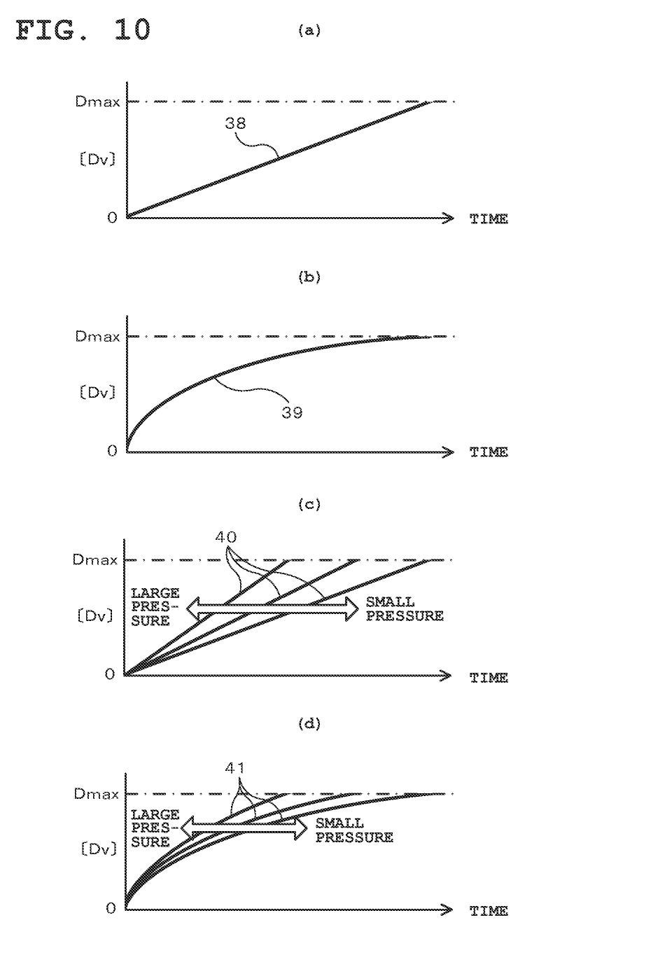

FIG. 10 is a diagram depicting a movement characteristic of the screen display position. In this drawing, (a) depicts a linear movement characteristic. That is, a characteristic line 38 linearly increases with time from Dv=0 to Dv=Dmax. Therefore, according to this, the screen display position can be moved at a predetermined speed (at a constant speed).

Also, (b) depicts a non-linear movement characteristic. That is, a characteristic line 39 increases with time like a quadratic function curve from Dv=0 to Dv=Dmax. Therefore, according to this, the screen display position can be moved initially at a high speed and then at a slow speed from a midway point to the end (at a variable speed).

Either one of the characteristics of the constant speed or the variable speed may be selected for use, as required. Also, the characteristic of the constant speed or the variable speed may be changed according to the pressures to grip the casing 11 (the measurement values FL and FR of the left pressure sensor 20 and the right pressure sensor 21).

For example, (c) depicts a linear movement characteristic (a constant-speed movement characteristic) provided with pressure responsiveness. That is, a plurality of characteristic lines 40 all linearly increase with time from Dv=0 to Dv=Dmax, but each has a different gradient of the straight line. Therefore, if one characteristic line is selected for use according to the magnitude of the pressure, the constant-speed movement characteristic can be provided with pressure responsiveness. That is, it is possible to provide pressure responsiveness such that the speed of the movement of the screen is increased when the casing 11 is gripped firmly or the speed of the movement of the screen is decreased when the casing 11 is gripped weakly.

Similarly, (d) also depicts a non-linear movement characteristic (a variable-speed movement characteristic) provided with pressure responsiveness. That is, a plurality of characteristic lines 41 all increase with time like a quadratic function curve from Dv=0 to Dv=Dmax, but each has a different gradient of the straight line. Therefore, if one characteristic line is selected for use according to the magnitude of the pressure, similarly, the variable-speed movement characteristic can be provided with pressure responsiveness. That is, it is possible to provide pressure responsiveness such that the speed of the movement of the screen is increased when the casing 11 is gripped firmly or the speed of the movement of the screen is decreased when the casing 11 is gripped weakly.

Any of these characteristics (a) to (d) is selected for use, as required.

Furthermore, while the “move destination” of the screen display position is fixed in the above description, the move destination may be variable.

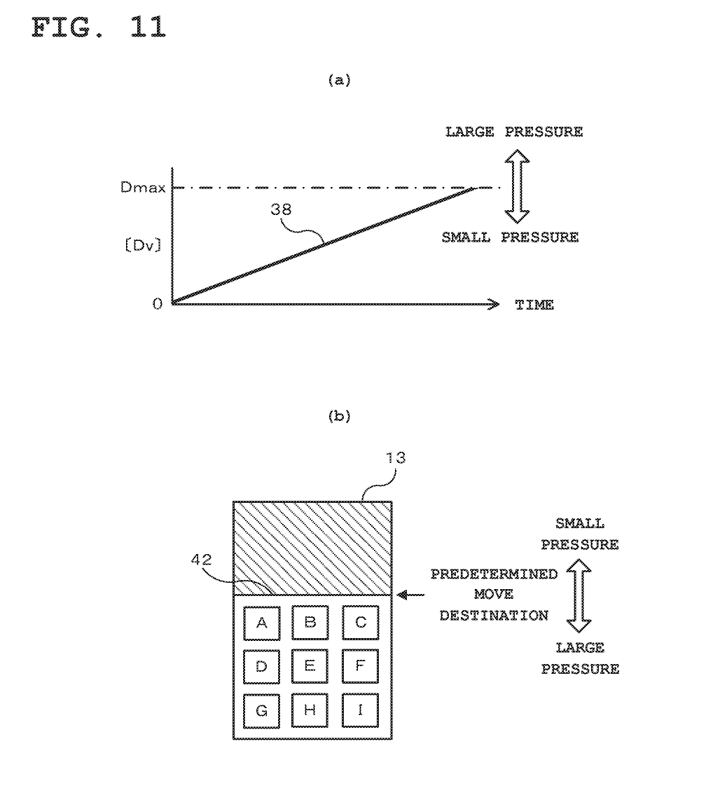

FIG. 11 is a conceptual diagram when the move destination is variable. As depicted in (a), the predetermined value (Dmax) represents the “move destination” of the screen display position, and therefore this Dmax may be changed according to the pressures (the measurement values FL and FR of the left pressure sensor 20 and the right pressure sensor 21). Note herein that while application to Dmax in the linear movement characteristic of FIG. 10(a) is depicted, this is not meant to be restrictive, and application may be made to any of FIG. 10(b) to FIG. 10(d).

When Dmax is changed according to the pressures (the measurement values FL and FR of the left pressure sensor 20 and the right pressure sensor 21), a move destination 42 of the display unit 13 is changed upward or downward as depicted in (b). Therefore, for example, the move destination 42 can be shifted downward when the casing 11 is gripped firmly or the movement destination 42 can be shifted upward when the casing 11 is gripped weakly, thereby allowing control over the movement amount of the screen according to the gripping force.

Still further, while the pressure sensors (the left pressure sensor 20 and the right pressure sensor 21) are provided on both side surfaces (the left side surface 18 and the right side surface 19), respectively, of the casing 11 in the above description, a mode may be such that a pressure sensor is provided either one of the side surfaces.

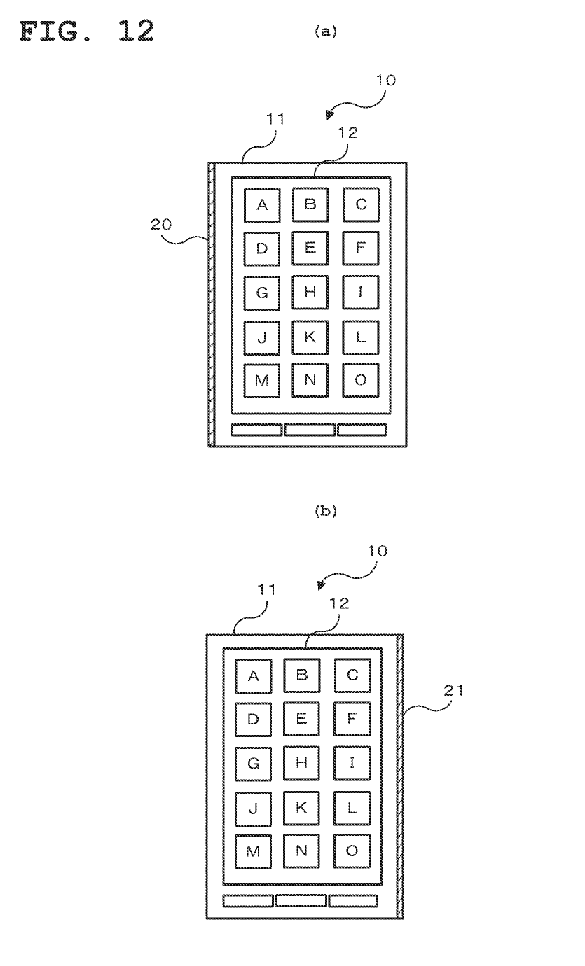

FIG. 12 is a diagram depicting a structure with one pressure sensor. As depicted in (a), only the right pressure sensor 20 may be provided. Alternatively, as depicted in (b), only the left pressure sensor 21 may be provided. As such, the gripping force of the casing 11 can be detected even with only one pressure sensor. However, in view of reliability of pressure detection, a mode is preferable such that pressure sensors (the left pressure sensor 20 and the right pressure sensors 21) are provided on both side surfaces (the left side surface 18 and the right side surface 19), respectively, of the casing 11.

Still further, in the above description, electrical pressure detecting means (the left pressure sensor 20 and the right pressure sensor 21) are used as means for detecting the gripping force of the casing 11, and the measurement values (FL and FR) and the threshold Fa are compared to distinguish between the normal gripping force f1 and the intentional gripping force f2 (or f2). However, this is not meant to be restrictive. Mechanical detecting means may be used.

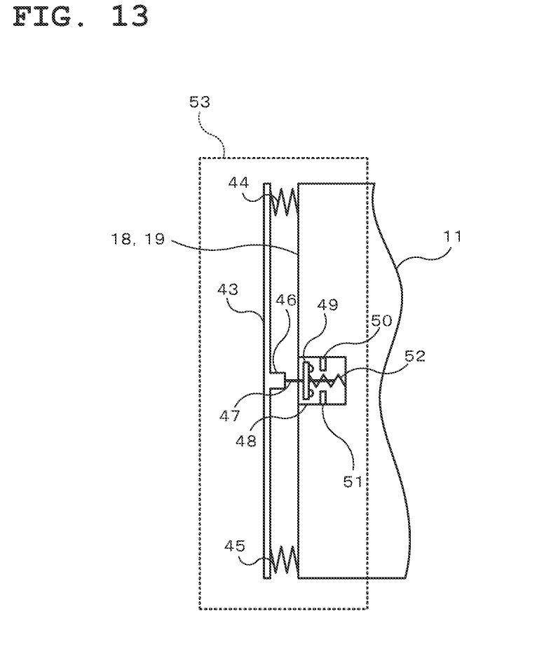

FIG. 13 is a diagram depicting an example of structure of mechanical pressure detecting means. In this drawing, plate-like pressuring members 43 are disposed on both side surfaces (the right side surface 18 and the left side surface 19) of the casing 11, with both ends of each of the pressuring members 43 mounted on the relevant side surface of the casing 11 via first and second elastic members 44 and 45. At an approximately intermediate position of the pressuring member 43, a projection 46 toward the side surface of the casing 11 is formed, and one end of a shaft 47 is fixed to that projection 46. The other end of the shaft 47 is inserted in a box 48 buried in the side surface of the casing 11, and a movable contact 49 is fixed near an approximately intermediate point of the shaft 47. Both ends of the movable contact 49 face fixed contacts 50 and 51 mounted on both walls of the box 48 with a predetermined space being kept. To keep this space, a third elastic member 52 is inserted in a compressed state between the movable contact 49 and a bottom surface of the box 48.

These units integrally structure mechanical pressure detecting means 53.

The pressuring member 43 is normally in a state of floating from the side surface of the casing 11 by elastic forces of the first and second elastic members 44 and 45 as well as the third elastic member 52. Similarly, the movable contact 49 is also in a state of floating from the fixed contacts 50 and 51 with a predetermined space. Therefore, the contacts at the normal time are in an OFF state.

Here, consider that the casing 11 is gripped with a weak force corresponding to the normal gripping force f1 described above. Here, the pressuring member 43 is being pressed onto the side surface of the casing 11 with a weak gripping force (corresponding to the normal gripping force f1). Now, it is assumed that the weak gripping force is on the order below a total elastic force of the first and second elastic members 44 and 45 and the third elastic member 52 (a force for deforming the elastic members 44 and 45 and the third elastic member 52 required for the pressurizing member 43 to make contact with the casing 11). In this case, since the elastic force surpasses the gripping force, the pressuring member 43 is still in a state of floating from the side surface of the casing 11. Similarly, the movable contact 49 is also in a state of floating with the predetermined space kept from the fixed contacts 50 and 51, and therefore the switch is kept in an OFF state.

Meanwhile, when the gripping force is intensified to the degree of exceeding the total elastic force (described above) of the first and second elastic members 44 and 45 and the third elastic member 52, that is, when the gripping force is set as a strong gripping force corresponding to the intentional gripping force f3 (or f2) described above, the pressurizing member 43 makes contact with the side surface of the casing 11, and the movable contact 49 and the fixed contacts 50 and 51 make contact with each other accordingly. Therefore, the switch makes a transition to an ON state.

As such, according to this structure, the switch can be caused to make a transition from OFF to ON by setting the gripping force from weak to strong. A switch ON/OFF transition point can be controlled with the total elastic force of the first and second elastic members 44 and 45 and the third elastic member 52, that is, the force for deforming the elastic members 44 and 45 and the third elastic member 52 required for the pressurizing member 43 to make contact with the casing 11. Therefore, by setting an elastic force according to a desired gripping force (a gripping force corresponding to the threshold Fa of the embodiment), as with the embodiment, it is possible to distinguish between the normal gripping force f1 and the intentional gripping force f3 (or f2).

Note that while the portable terminal apparatus 10 having the portable telephone function such as a smartphone is taken as an example for description in the embodiment, this is not meant to be restrictive. Any electronic device can be used as long as the electronic device includes a display unit equipped with a touch panel and an operation with one hand is required to be performed. For example, a game machine, a tablet PC, a notebook PC, an electronic dictionary, an electronic book terminal, etc. may be used.

In the following, features of the present invention are described as supplementary notes.

The whole or part of the above embodiment can be described as, but not limited to, the following supplementary notes.

### (Supplementary Note 1)

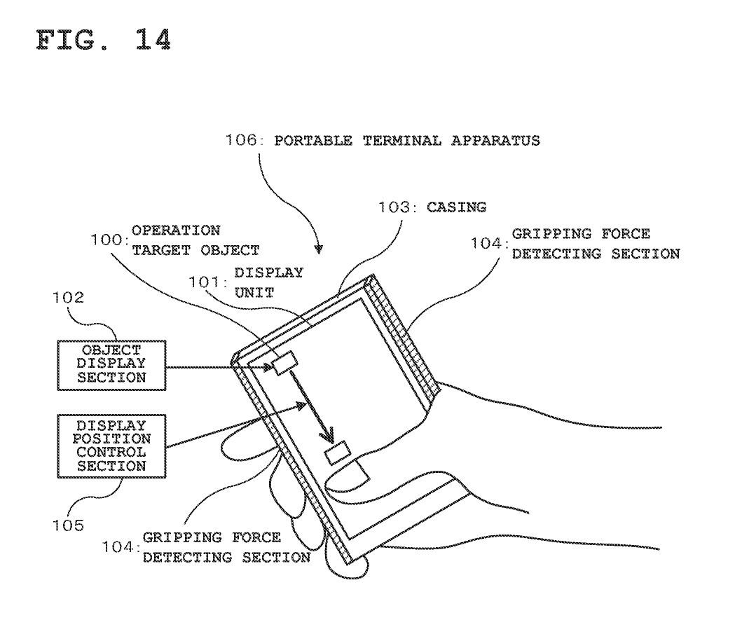

FIG. 14 is a diagram depicting a structure of Supplementary Note 1.

Supplementary Note 1 provides a portable terminal apparatus 106 (corresponding to the portable terminal apparatus 10 of the embodiment) comprising:

object display means 102 (corresponding to the main control unit 23 of the embodiment) which causes at least one operation target object 100 to be displayed on a display unit 101 (corresponding to the display unit 13 of the embodiment);

gripping force detecting means 104 (corresponding to the left pressure sensor 20 and the right pressure sensor 21 of the embodiment) which detects a gripping force added to a casing 103 (corresponding to the casing 11 of the embodiment); and

display position control means 105 (corresponding to the main control unit 23 of the embodiment) which controls a display position of the operation target object 100 on the display unit 101 according to the gripping force detected by the gripping force detecting means 104.

### (Supplementary Note 2)

Supplementary Note 2 provides the portable terminal apparatus according to Supplementary Note 1, wherein

the display position control means moves the display position of the operation target object on the display unit to a position where an operation with one hand can be performed when the gripping force exceeds a predetermined threshold, and moves the display position of the operation target object for return to an original position when a state in which the gripping force exceeds the predetermined threshold is changed to a state in which the gripping force becomes below the predetermined threshold.

### (Supplementary Note 3)

Supplementary Note 3 provides the portable terminal apparatus according to Supplementary Note 2, wherein

the display position control means moves the display position of the operation target object to the position where the operation with one hand can be performed, at a constant speed or a variable speed.

### (Supplementary Note 4)

Supplementary Note 4 provides the portable terminal apparatus according to Supplementary Note 3, wherein

the display position control means changes a movement characteristic of the display position of the operation target object correspondingly to the gripping force detected by the gripping force detecting means.

### (Supplementary Note 5)

Supplementary Note 5 provides the portable terminal apparatus according to Supplementary Note 2, wherein

the display position control means changes a position of a move destination of the display position of the operation target object correspondingly to the gripping force detected by the gripping force detecting means.

### (Supplementary Note 6)

Supplementary Note 6 provides a portable terminal control method comprising:

an object display step of causing at least one operation target object to be displayed on a display unit;

a gripping force detecting step of detecting a gripping force added to a casing; and

a display position control step of controlling a display position of the operation target object on the display unit according to the gripping force detected in the gripping force detecting step.

### (Supplementary Note 7)

Supplementary Note 7 provides a program providing a computer of a portable terminal apparatus with functions as

object display means which causes at least one operation target object to be displayed on a display unit;

gripping force detecting means which detects a gripping force added to a casing; and

display position control means which controls a display position of the operation target object on the display unit according to the gripping force detected by the gripping force detecting means.

### DESCRIPTION OF REFERENCE NUMERALS

100 operation target object
101 display unit
102 object display means
103 casing
104 gripping force detecting means
105 display position control means
106 portable terminal apparatus

1. A portable terminal apparatus comprising:
an object display section which causes at least one operation target object to be displayed on a display unit;
gripping force detecting section which detects a gripping force added to a casing; and
display position control section which controls a display position of the operation target object on the display unit according to the gripping force detected by the gripping force detecting section.

2. The portable terminal apparatus according to claim 1, wherein the display position control section moves the display position of the operation target object on the display unit to a position where an operation with one hand can be performed when the gripping force exceeds a predetermined threshold, and moves the display position of the operation target object for return to an original position when a state in which the gripping force exceeds the predetermined threshold is changed to a state in which the gripping force becomes below the predetermined threshold.

3. The portable terminal apparatus according to claim 2, wherein
the display position control section moves the display position of the operation target object to the position where the operation with one hand can be performed, at a constant speed or a variable speed.

4. The portable terminal apparatus according to claim 3, wherein
the display position control section changes a movement characteristic of the display position of the operation target object correspondingly to the gripping force detected by the gripping force detecting section.

5. The portable terminal apparatus according to claim 2, wherein
the display position control section changes a position of a move destination of the display position of the operation target object correspondingly to the gripping force detected by the gripping force detecting section.

6. A portable terminal control method comprising:
an object display step of causing at least one operation target object to be displayed on a display unit;
a gripping force detecting step of detecting a gripping force added to a casing; and
a display position control step of controlling a display position of the operation target object on the display unit according to the gripping force detected in the gripping force detecting step.

7. A non-transitory computer-readable storage medium having a program stored thereon that is executable by a computer in a portable terminal apparatus to perform functions comprising:
object display section which causes at least one operation target object to be displayed on a display unit;
gripping force detecting section which detects a gripping force added to a casing; and
display position control section which controls a display position of the operation target object on the display unit according to the gripping force detected by the gripping force detecting section.
